(19) United States
(12) Patent Application Publication
(10) Pub. No.: US 2016/0097744 A1
(43) Pub. Date: Apr. 7, 2016

(54) METHOD FOR DETERMINING ACOUSTIC VELOCITY IN A POROUS MEDIUM

(71) Applicant: SCHLUMBERGER TECHNOLOGY CORPORATION, Sugar Land, TX (US)

(72) Inventors: Aleksei Alexandrovich Shevchenko, Moscow (RU); Vladimir Viktorovich Abashkin, Moscow (RU); Dmitry Alexandrovich Belov, St.Petersburg (RU)

(21) Appl. No.: 14/874,051

(22) Filed: Oct. 2, 2015

(30) Foreign Application Priority Data
Oct. 3, 2014 (RU) 2014139978

(51) Int. Cl. G01N 29/07

(52) U.S. Cl. CPC G01N 29/07; G01N 2291/011

(57) ABSTRACT

At least two samples of a porous medium with different lengths are exposed to acoustic waves emitted by a source. For each sample, acoustic wave arrival times are registered at a receiver and acoustic propagation velocity in the porous medium is determined by analyzing changes in the arrival times relative to changes in the lengths of the samples.

### CROSS-REFERENCE TO RELATED APPLICATION

This application claims priority to Russian Application No. 2014139978 filed Oct. 3, 2014, which is incorporated herein by reference in its entirety.

### BACKGROUND

The disclosure relates to acoustic analysis of porous materials, in particular, core samples.

Determining acoustic velocity in core samples is one of the most important core analysis procedures. Acoustic velocities of compressional and shear waves describe elastic properties of a rock sample and can be compared with velocities measured by logging tools in the rocks where core samples were taken from. Elastic wave velocity is an important property of rocks since it depends on the presence of pore space and the pattern of formation fractures. Therefore, exact determination of elastic wave velocities is essential for correct characterization of reservoir rocks on hydrocarbon fields.

Elastic wave velocities in a core can be measured by a standard laboratory apparatus (e.g., see E. Fjær, R. M. Holt, P. Horsrud, A. M. Raaen & R. Risnes, “Petroleum Related Rock Mechanics”, p.261-262, Elsevier B. V., 2008, or ASTM D2845-08 Standard Test Method for Laboratory Determination of Pulse Velocities and Ultrasonic Elastic Constants of Rock).

The principle of velocity measurement is based on measuring wave travel time in one core sample of a known length. In order to measure wave travel time, a source and a receiver are attached at the opposite ends of a core sample. The source contains a piezoceramic element emitting elastic oscillations at the core sample boundary. The receiver contains a piezoceramic element transforming core wall oscillations into electric signal. The received signal is digitized and recorded into a file for further visual or computer analysis of the recorded signal.

The time elapsed from the moment when the source has emitted the signal to the moment when the receiver has registered the signal is measured and used as a basis for determining elastic wave propagation velocity in the core sample. A source emitting longitudinal oscillations is used to determine compressional wave (P-wave) velocity. A source emitting shear oscillations is used to determine shear wave (S-wave) velocity. Both source types are not ideal; therefore, they emit all types of waves together with their primary types of waves, P or S.

The travel time in a core sample is determined at the recording processing phase, visually or using a computer processing software. In order to determine travel time, acoustic signal emitted by the source should be analyzed and signal start time should be selected. Normally, oscillation waveforms emitted by the source are not simple and have more than one peak. Therefore, an error in selecting the initial phase of the acoustic signal can lead to significant error in determining acoustic velocity.

Using of an exact signal starting point leads to errors in determining acoustic velocity caused by measurement inaccuracies introduced by both instrument and acoustic noises. S-waves are especially prone to errors and noises when determining their propagation velocity. S-waves have greater arrival times, when P-waves already have formed interference field in the core resulting from mirroring and various incoherent noises. The interference of the direct S-wave and noise does not allow the arrival time to be determined exactly and definitely and thus results in gross measurement inaccuracies.

### SUMMARY

The proposed method provides for an improved accuracy of determining acoustic wave velocities, higher noise immunity and simpler interpretation of the measured data. Besides, the proposed method is insensitive to source waveform changes and selection of the arrival time for the incoming wave.

According to the proposed method, at least two samples of a porous medium with different lengths are exposed to acoustic waves emitted by a source. For each sample, acoustic wave arrival times are registered at a receiver and acoustic propagation velocity in the porous medium is determined by analyzing changes in the arrival times relative to changes in the lengths of the samples.

The analysis of the changes in the wave arrival times can be made in time domain using a semblance operator, or in frequency domain using a Proni transform.

The samples of the porous medium of different lengths can be made by a stepwise reduction of length of the same sample.

The lengths of the sample can gradually increase with a constant step.

The acoustic waves can be compressional (P) waves or shear (S) waves.

A rock core can be used as the porous medium sample.

### BRIEF DESCRIPTION OF DRAWINGS

The invention is illustrated by drawings, wherein:

FIG. 1 shows an apparatus for measurement of a core sample set;

FIG. 2 shows a set of recordings for six samples of different lengths;

FIG. 3 shows a result of determining P-wave acoustic velocity in the time domain based on a semblance operator estimate; and

FIG. 4 shows a result of determining P-wave acoustic velocity in the frequency domain based on a Proni transform.

### DETAILED DESCRIPTION

In order to make velocity measurements more accurate and noise-resistant, this disclosure describes a new approach to determine elastic wave velocity based on comparing acoustic measurement records made on a collection of samples with different lengths. In this case, travel time in core samples with different lengths is determined by the difference of measured times in several samples, rather than by absolute time. Because of that, the signal start time has no effect on measured velocity. Elimination of the start time error and improved measurement statistics allow the method accuracy to be increased and measured data interpretation to be simplified and automated.

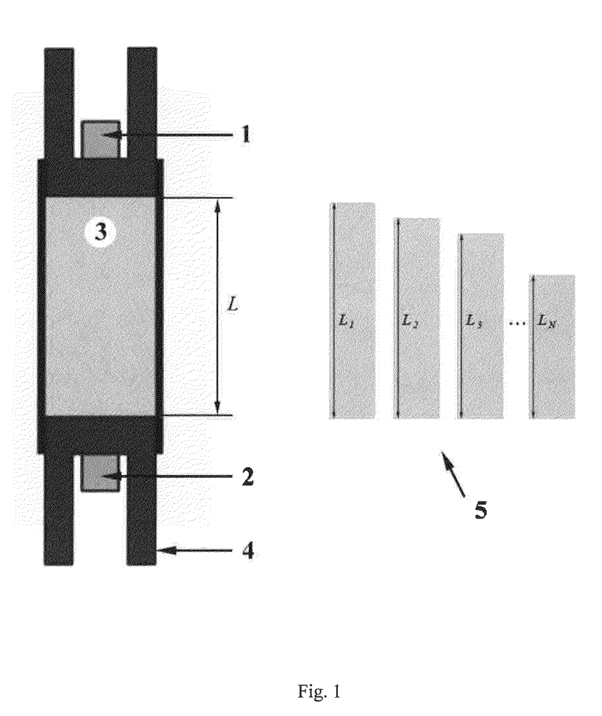

A standard acoustic unit can be used to implement the proposed acoustic velocity measurement method. At least two core samples with different lengths are selected for measurements. Also, one core sample can be selected for sequential measurements, whereby its length is gradually reduced (by cutting off or grinding the sample to obtain the required length). FIG. 1 shows an apparatus for measurements on N core samples of different lengths. The following devices are used for the experiment: 1—a piezoceramic source, used for emitting elastic waves, 2—a piezoceramic receiver, used for recording of oscillations, and 3—a sample. The source 1 and the receiver 2 are placed at the opposite planes of cylindrical core sample 3 secured in a core holder 4. The source and the receiver can be attached to the core ends using different methods. The attachment method depends on the laboratory equipment design. The contacts between (i) the source and the core sample and (ii) the receiver and the core sample should be rigid and free of any gaps. The rigid contact prevents absorption of elastic wave energy when waves are emitted and recorded and minimizes noise during experiment.

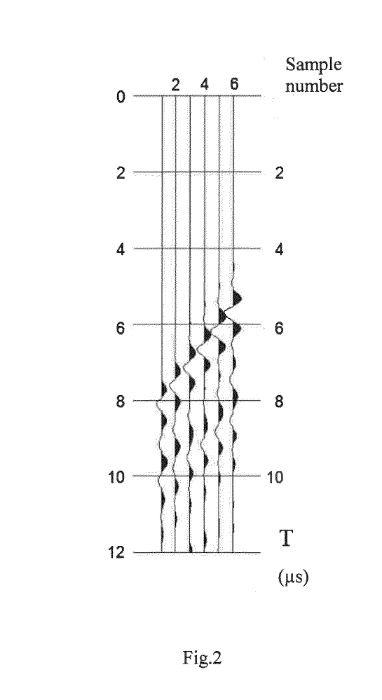

As a result of measurements carried out on the samples (5) with different lengths, a set of records is obtained where each record corresponds to a certain length of the sample (see FIG. 2). The measurements can be made using different types of signal sources. It is important to obtain a set of records which can be used to estimate differences in elastic wave travel times from the source to the receiver.

The set of records is processed in order to measure changes in the wave arrival times on the records, rather than absolute travel times, for different sizes of core samples or for core samples with differences in other properties.

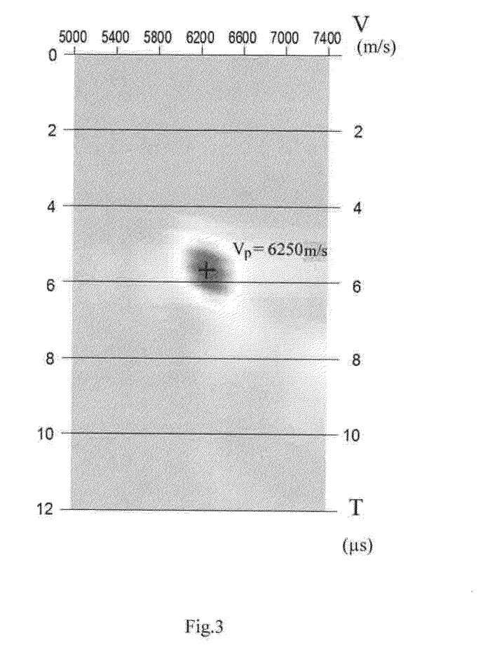

Acoustic velocity is determined by measuring changes in arrival times (event dip, FIG. 3) relative to changes of the sample lengths.

The benefits of multiple measurements is based on the fact that the selected P- or S-waves have the same recorded waveform during various measurements (traces) and different arrival times due to different distances between the source and the receiver or differences in medium properties. Different methods can be applied to obtain time-distance curves on all records simultaneously. All these methods can be grouped into two types. The first type uses time-domain processing and the second type uses frequency-domain processing, following the Fourier transform of the measured data.

One potential time-domain processing algorithm is based on finding a maximum of function called semblance:

$$S ( {t}_{i} , Δ t ) = \frac{{\sum }_{t = {t}_{i}}^{{t}_{i} + M} {( {\sum }_{n = \frac{N - 1}{2}}^{\frac{N - 1}{2}} {u}_{n} ( t + n Δ t ) )}^{2}}{N {\sum }_{t = {t}_{i}}^{{t}_{i} + M} ( {\sum }_{n = \frac{N - 1}{2}}^{\frac{N - 1}{2}} {u}_{n}^{2} ( t + n Δ t ) )} \qquad ( 1 )$$

In this formula, estimated S(tᵢ, [symbol] t) is calculated from the set of measurements uₙ(t). Here, t reflects changes in time, n is a measurement number, [symbol] t controls changes in time or arrival time offset for a changed number of measurement. Analysis is performed on a set of N measurements. Outer summing, both in the numerator and denominator, is performed for time averaging in the window from M measurements. The inner sum in the numerator and denominator assumes that signals are summed with different [symbol] t offsets. The offset is an enumeration parameter, it reflects the dependency of estimated semblance and the sought wave velocity:

$$V = \frac{Δ t}{Δ x} \qquad ( 2 )$$

where x defines changes in the source-to-receiver distance between two measurements. The velocity parameter V is actually a slope of the arrival-time curve (time-distance curve) of the analyzed wave. Normally, the waveform of the incoming wanted wave, noise level and frequency content are considered to be unknown; therefore the formula (1) for calculating the estimated S(tᵢ, [symbol] t) may be changed, but its meaning of estimating wave energy along a set of different time-distance curve slopes will be preserved.

The time-domain analysis of acoustic velocities is based on measuring time-distance curve slope, which is proportional to the velocity value (2). The Proni transform is one widely known approach to numerical realization of this procedure (W. Lang, A. L. Kurkjian, J. H. McClellan, C. F. Morris, T. W. Parks, “Estimating slowness dispersion from arrays of sonic logging waveforms,” Geophysics, vol.52, p 530-544, 1987). The Proni transform and its modifications are based on frequency decomposition of wavefield using the Fourier transform.

If we designate measurements on core sample series as u(xₙ,t), where t is a recording time, and n defines a number of measurement. Coordinate xₙ is normally changing with a constant step (xₙ=x₀+Δx). Fourier spectral decomposition is made for a seismogram consisting of N traces. For each trace recorded at reception point xₙ the Fourier transform provides information about all waves physically measured in the core:

U(xₙ,ω)=∫u(xₙ,t)e^{jωt}dt (3)

For each trace (n) and the fixed frequency (ω), the plane wave will be represented by a harmonic component with an amplitude aᵢ and a phase shift kᵢ, which depends on wave tilt on the initial wave field. Therefore, the field at a given frequency ω₀ will appear as:

$$U ( {x}_{n} , {ω}_{0} ) = {\sum }_{i = 1}^{p} {a}_{i} {e}^{- j {k}_{i} {x}_{n}} \qquad ( 4 )$$

The number p defines the number of regular waves in the analyzed wave field. The wave tilt can be used to determine the velocity (Vᵢ) or interval travel time (sᵢ) (slowness)

$${s}_{i} = \frac{1}{{V}_{i}} = \frac{{k}_{i}}{{ω}_{0}} \qquad ( 5 )$$

In Hsu K, Baggeroer A. B. Application of the maximum likelihood method (MLM) for sonic velocity logging: 1986. Geophysics, 51, 780-787, [symbol] R. Kumaresan and D. W. Tufts, “Estimating the parameters of exponentially damped sinusoids and pole-zero modelling in noise,” IEEE Trans. Acoustics, Speech, Signal Processing, vol.30, pp.833-840, 1982, it was demonstrated that during approximation of spectrum with a set of p complex exponents, the exponent arguments (poles) are common values of the matrix pairs, i.e. they are solutions of a matrix equation:

([U0]−λ[U1])e=0 (6)

where matrices U0 and U1 are created from values u(n) such that:

$$U 0 = [ \begin{matrix}u ( 2 ) & u ( 3 ) & … & u ( p + 1 ) \\ u ( 3 ) & u ( 4 ) & … & … \\ … & … & … & … \\ u ( m - p + 1 ) & … & … & u ( m )\end{matrix} ] and$$

$$U 1 = [ \begin{matrix}u ( 1 ) & u ( 2 ) & … & u ( p ) \\ u ( 2 ) & u ( 3 ) & … & … \\ … & … & … & … \\ u ( m - p ) & … & … & u ( m - 1 )\end{matrix} ] .$$

Solutions to equation (6) can be used to find sᵢ and (5) is used to determine P-wave or S-wave velocities for each value of the frequency.

As result of processing measured data, the proposed method provides the velocity value, which is calculated from the measured data by formula (2) or (5), depending on which method, time-domain or frequency-domain, was used for measured data analysis.

Thus, as distinct from the standard method whereby only one measurement is used, the proposed method uses all N measurements simultaneously to determine acoustic velocity. Measured data analysis and velocity determination can be processed in time-domain based on estimating the semblance function or in frequency-domain using the Proni transform. Other data transformation and interpretation methods can also be applied for processing measured data. The novelty of the proposed method is that it uses a set of measurements to determine relative changes of arrival times, which results in a more consistent acoustic velocity determination and higher accuracy.

Below some examples of determining acoustic velocities with processing in time and frequency domains are provided.

Measured data processing in time domain:

In order to determine P-wave acoustic velocity based on measured data (FIG. 2), the semblance parameter is estimated. FIG. 3 shows an example of determining P-wave acoustic velocity in time domain and a result of semblance estimation S(tᵢ, [symbol] t). The vertical axis represents the time of measured oscillation and describes the analysis window position relative to time (tᵢ—in formula (1)). The horizontal axis is graduated in velocity values converted from Δt in (1) into velocity using formula (2). The coherency peak observed at 5.86 mks time has the slope value which corresponds to the P-wave propagation velocity of 6250 m/s.

Velocity estimate was obtained for the data where acoustic signal was generated by a P-wave source. In case of the S-wave, this procedure can be used for simultaneous determination of P-wave and S-wave velocities. However, from the noise immunity point of view, only velocity of the same type of wave that the source is designed to generate should be determined.

Measured data processing in frequency domain:

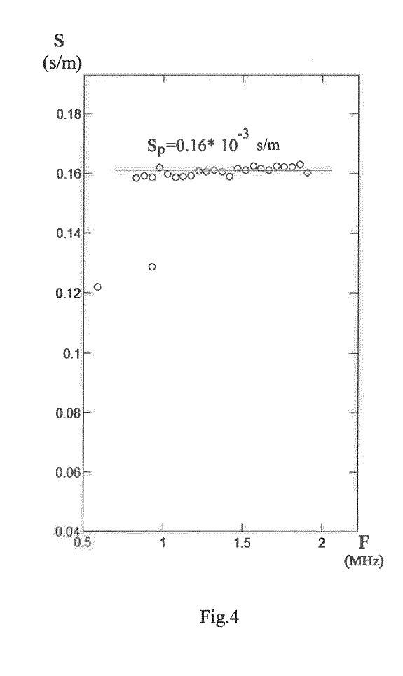

Measured data (FIG. 2) are subject to the Fourier transform by the temporal coordinate and to the Proni transform. FIG. 4 shows an example of determining P-wave propagation velocity with frequency-domain transform and distribution of travel times (slowness) vs frequency. The Proni transform is applied in the same manner, regardless of how the method is used in sonic logging. All known state-of-the-art approaches and modifications of the Proni transform can be used to analyze measured data obtained from a set of multiple core samples.

1. A method for determining acoustic velocity in a porous medium, the method comprising:
exposing at least two samples of a porous medium having different lengths to acoustic waves emitted by a source;
for each sample, registering acoustic wave arrival times at a receiver for the acoustic waves emitted by the source; and
determining acoustic propagation velocity in the porous medium by analyzing changes in the acoustic wave arrival times relative to changes in the lengths of the samples.

2. The method of claim 1, wherein the analysis of the changes in the wave arrival times is made in time domain.

3. The method of claim 2 wherein the analysis in the time domain is made using a semblance operator.

4. The method of claim 1, wherein the analysis of the changes in the wave arrival times is made in a frequency domain.

5. The method of claim 4 wherein the analysis in the frequency domain is made using a Proni transform.

6. The method of claim 1, wherein the samples of different lengths are obtained by successive reduction of a length of one sample.

7. The method of claim 1, wherein the lengths of the samples gradually increase with a constant step.

8. The method of claim 1, wherein the acoustic waves are compressional waves.

9. The method of claim 1, wherein the acoustic waves are shear waves.

10. The method of claim 1, wherein a rock core is used as a sample of the porous medium.
